(19) United States
(12) Patent Application Publication
(10) Pub. No.: US 2019/0087922 A1
(43) Pub. Date: Mar. 21, 2019

(54) Method for offering ecological classified real estate properties

(71) Applicant: Jesus Ureta Martin, Melilla (ES)

(72) Inventor: Jesus Ureta Martin, Melilla (ES)

(21) Appl. No.: 16/125,789

(22) Filed: Sep. 10, 2018

Related U.S. Application Data
(60) Provisional application No. 62/560,207, filed on Sep. 19, 2017.

(51) Int. Cl. G06Q 50/16; G06Q 30/00; G06Q 50/18

(52) U.S. Cl. CPC G06Q 50/16; G06Q 50/188; G06Q 30/018

(57) ABSTRACT

A method to offer ecologically classified real estate properties that creates a general list of ecological properties stored on the website of the main office and classified according to 25 listed ecological criteria.

### BRIEF SUMMARY OF THE INVENTION

The invention relates to a real estate portal devoted to ecological homes, with greater interior comfort and minimal electrical expense, constructed ethically and responsibly with natural materials.

### BRIEF DESCRIPTION OF THE SEVERAL VIEWS OF THE DRAWING

Not applicable

### DETAILED DESCRIPTION OF THE INVENTION

An ecological home must have among its standards some of the following elements.

### Construction and Soundproof Materials

1. Natural and unadulterated materials.

2. Nontoxic materials that are odorless or pleasant-smelling

3. Low radioactivity materials.

4. People-oriented acoustic and anti-vibration protection.

### Interior Environment

5. Natural regulation of atmospheric humidity through the use of hygroscopic materials.

6. Minimisation and rapid dissipation of humidity from the new construction work.

7. Balanced proportion of thermal insulation and accumulation of heat.

8. Optimal temperatures of the surfaces and the ambient air.

9. Good ambient air quality thanks to natural renewal.

10. Radiant heat for heating.

11. Minimal alteration of the natural radiation environment.

12. Absence of electromagnetic fields and radio waves in expansion.

13. Reduction of the presence of fungus, bacteria, dust and allergens.

### Environment, Energy and Water

14. Minimisation of the consumption of energy, using to the maximum possible renewable energy sources.

15. Construction materials coming from, preferably, the region and that do not favour the abusive exploitation of scarce or hazardous raw materials.

16. Prevention of problems for the environment.

17. Optimal quality possible of drinking water.

### Interior Design

18. Respect of the dimensions, proportions and harmonious shapes.

19. Natural conditions of light, lighting and colours.

20. Use of the knowledge of physiology and ergonomics in the decoration and the equipping of the interior space.

### Plot

21. Absence of natural and artificial plot of land.

22. Dwellings far from sources of contaminating and noise emissions.

23. Method of decentralised and flexible construction in landscaped housing developments.

24. Dwelling and residential environment, closely related to nature, worthy of and compatible with family life.

25. Absence of negative social sequelae.

These are the 25 rules that define an ecological home.

For the qualification of the house each rule will be graded with a score between 0 and 4 points, obtaining a final result that goes from 0 (worst result) to 100 points (maximum according to these rules).

The score obtained is displayed in a percentage that indicates how ecological the property is according to the criteria of bioconstruction, coining the term “conseconected®” to distinguish it from the rest of other ecological certifications.

Therefore, as an example, a property that has obtained a score of 85 points will obtain a qualification of “85% conseconected®”.

The purpose of the valuation of the properties according to the bioconstruction rules is for all the ads to have a qualification realised by specialists that certifies the shown information, and adds information to the Energy Efficiency Label (31). Furthermore, it is to spread an increasingly greater interest in ecological homes, more sustainable and with the least environmental impact possible.

In order to evaluate the property, the specialist in bioconstruction will go in an ecological vehicle, whenever there is no public transportation to your location. These may be electric or hydrogen fuel cell motors, and they are known by their ecological vocation of environmental sustainability as “vehécolos®”

As a complement to the previous score, along with each ad the Energy Efficiency Label (31) must be shown.

If the property has any other official certification, this must also be included in the ad. These may be the following:
LEED® Certification (26) (Leadership in Energy in Environmental Design) developed by the US Green Building Council (USGBC)
BREEAM® (27) Certification (BRE Environmental Assessment Method)
VERDE® (28) Certification (from the Green Building Council Spain)
PASSIVHAUS® (29) Certification (from the Passivhaus Institut of Germany)
Lifecycle Analysis (30) of the Asociación Ecómetro®.

It deals with displaying the most information possible on the dwelling in ecological terms.

The search engine of this real estate portal allows searching from the ecological point of view, apart from the traditional parameters of property type (house, apartment, commercial premises, etc.), negotiation type (sale, lease, temporary lease), country, city, area, price range, number of rooms, size, number of bathrooms, etc.

This search according to ecological criteria allows searching for properties according to the following parameters:
Search for properties with a minimum ecological score according to the bioconstruction rules, selected by the user, and their classification upon being shown (they are shown in order of the score).
Search for properties that have the Energy Efficiency Label letter A (31).
Limit the search only to properties that have LEED® (26), BREEAM® (27), VERDE® (28) or PASSIVHAUS® (29) Certification.
Compare properties visually with the graphic of the Lifecycle Analysis (30) of the properties that have it.

The website also includes a special section entitled “Ideal House” in which the user is asked different questions and depending on the answers he chooses (from the ones the page provides) the computer program decides what would be the ideal home of the user, based on a previously programmed algorithm.

Some of the questions would have “yes” or “no” answers, i.e if you suffer from any environmental disease, so that homes located in congested areas or with high rates of pollution are discarded.

Other answers would have a scoring range, focusing in the importance that is given to certain aspects, for example the proximity of parks (32), giving it a score from a range, so that if an specific feature is considered essential it is given the highest score, or the lowest score if it is not important to the user.

There would be a third type of questions characterized because the user has to choose among several available options, such as choosing housing in dense (33) or open (34) spaces.

And finally a series of options to mark regarding the requirements that the house must have, such as home automation (35).

When finished, the program will show the most suitable homes according to the answers obtained, with all the information available about them, and their visualization on a map informing of the air quality of the area in real time.

By selecting one of the houses, all the aforementioned information about said hose is shown, such as the Energy Efficiency Label (30), official ecological certifications (26/29) and the score obtained according to the bioconstruction rules 25.

In the same space it is also indicated if the house has solar panels (36) or wind turbines (37), as well as facilities for charging electrical vehicles (38) and informs of its power in the case of shared garages.

In addition, the distance to the nearest public electric vehicle charging station nearest the home is also shown.

In homes with home automation installation (35) it will be specified if this was done using bioconstruction criteria.

These criteria are based on automation being carried out in the most natural way: For example, the automation that raises the blinds so that natural light enters during the day, instead of turning on lights or unnecessary heating.

Also taking into account keeping electrical appliances, antennas, boosters and transmitters at a safe distance from the rest spaces, to avoid as much as possible of the continuous electric and alternating electric fields.

The term used for these domotic installations made with bioconstruction criteria will be “Biodomotics” (38), so that in the home profile it is possible to distinguish at first sight from the places with a domotic installation that did not have these principles in mind.

Finally, a section of the web page will highlight houses with a vegetal facade (40) or vertical gardens (41) and those with an ecological vegetable garden (42) already cultivated.

The characteristics of this project of Ecological Real Estate Portal are also designed for the creation of a mobile application similar to the web project but more focussed on the location of the user for the search of properties in a local area.

Furthermore, there is also the possibility of advertising these properties in a commercial establishment like a real estate office, where it explains to the possible users the benefits of living in one of the dwellings constructed with the ecological criteria described earlier.

The project consists of a system and a method for offers of real estate properties dedicated to ecological homes, of greater interior comfort and minimal energy use, built in an ethical and responsible manner with natural materials.

The method consists in that all the information of the ecological housings are filed in a general list (50) of ecological buildings, stored in the central office's website (51)

This general list (50) is mainly fed by two types of media:
by independent search engines (52) and also by
customers/suppliers (53) who offer their property of an ecological nature, and may include the price.

This general list (50) by means of an interface (54) of the server (55) of the central office's website (51) controlled by an order algorithm (56) creates a list (57) classified by known ecological criteria.

From this moment, an external client (58), by means of any electronic device (60), communicates with the central office's website (51) that offers a code for starting the session (59).

With this login code (59) you can access the classified ecological list (57) that contains all the complete information related to each property, including the price.

By means of a selective search interface (65), the external customer (58) can segment the search by criteria: price, bio-domotic preferences (36), certifications, energy efficiency and so on up to 110 different parameters.

Within a selective offer interface (66) the external customer (58) can make an offer to each of the properties that are of interests to him.

The customer/supplier (53) from his mobile device can request from the central office's website (51) an owner code (67) in order to access when deemed convenient to his property located in the classified ecological list (57) , owner section (68) where you can verify the visits your property has had, the comments left and if you have received any counter-price offer.

If you think it convenient, you can modify the price or conditions.

1. A method to offer ecologically classified real estate properties and whose information is included in a general list of ecological properties, stored on the website of the main office and referred to wherein the following ecological criteria are established:
1. construction and soundproof materials
2. natural and unadulterated materials
3. nontoxic materials that are odorless or pleasant-smelling
4. low radioactivity materials
5. people-oriented acoustic and anti-vibration protection
1. interior environment
6. natural regulation of atmospheric humidity through the use of hygroscopic materials
7. minimization and rapid dissipation of humidity from the new construction work
8. balanced proportion of thermal insulation and accumulation of heat.
9. optimal temperatures of the surfaces and the ambient air
10. good ambient air quality thanks to natural renewal
11. radiant heat for heating
12. minimal alteration of the natural radiation environment
13. absence of electromagnetic fields and radio waves in expansion
14. reduction of the presence of fungus, bacteria, dust and allergens
15. environment, energy and water
16. minimization of the consumption of energy, using to the maximum possible renewable energy sources
17. construction materials coming from, preferably, the region and that do not favor the abusive exploitation of scarce or hazardous raw materials
18. prevention of problems for the environment
19. optimal quality possible of drinking water
20. interior design
21. respect of the dimensions, proportions and harmonious shapes
22. natural conditions of light, lighting and colors
23. use of the knowledge of physiology and ergonomics in the decoration and the equipping of the interior space
24. plot
25. absence of natural and artificial plot of lan
26. dwellings far from sources of contaminating and noise emissions
27. method of decentralized and flexible construction in landscaped housing developments
28. dwelling and residential environment, closely related to nature, worthy of and compatible with family life
29. absence of negative social sequelae.

2. The method according to claim 1 wherein the information for the website of the main office is supplied by:
independent search engines,
and also by customers/suppliers that offer their ecological property, including price.

3. The method as described in claim 1 wherein there is a server interface that configures a classified list by level of compliance with ecological standards and where the method to access to the classified list from any electronic device of a future client includes providing the client with a session start code, with which he has access to the classified list and with the same login code you also have access to the price of the selected property,
and where the method allows through a selective search interface, the client can segment the search by criteria: price, bio-domotic preferences, certifications, energy efficiency and so on up to 110 different parameters.
and where in the method, the client within a selective offer interface can make an offer to each of the properties visited that interests him.

4. The method according to claim 2 wherein the supplier from his mobile device can request from the website of the main office an owner code in order to access his property located in the classified ecological list, owner section where you can verify the visits your property has had,
and that also includes the comments that the clients have left and if they have received any counter-price offer,
and that also includes the possibility of modifying the price or the conditions of your ecological property.
